(19) United States
(12) Patent Application Publication
(10) Pub. No.: US 2025/0326915 A1
(43) Pub. Date: Oct. 23, 2025

(54) COMPOSITE MATERIAL STRUCTURE WITH CO2 DERIVED MATERIALS

(71) Applicant: SkyNano LLC, Louisville, TN (US)

(72) Inventors: Anna E. DOUGLAS, Knoxville, TN (US); Hicham GHOSSEIN, Knoxville, TN (US)

(73) Assignee: SkyNano LLC, Louisville, TN (US)

(21) Appl. No.: 19/182,502

(22) Filed: Apr. 17, 2025

Related U.S. Application Data
(60) Provisional application No. 63/636,034, filed on Apr. 18, 2024.

(51) Int. Cl. C08K 7/06; C08J 9/00; C25B 1/135

(52) U.S. Cl. CPC C08K 7/06; C08J 9/0085; C25B 1/135; C08K 2201/004

(57) ABSTRACT

Composite materials and methods of manufacturing the same are described herein. The composite materials include electrochemically synthesized carbon structures manufactured using CO₂ as a carbon source. The composite structures can further include cellulosic fibers and carbon waste fibers. The composite materials are manufactured using a method which provides negative embodied carbon in the composite material.

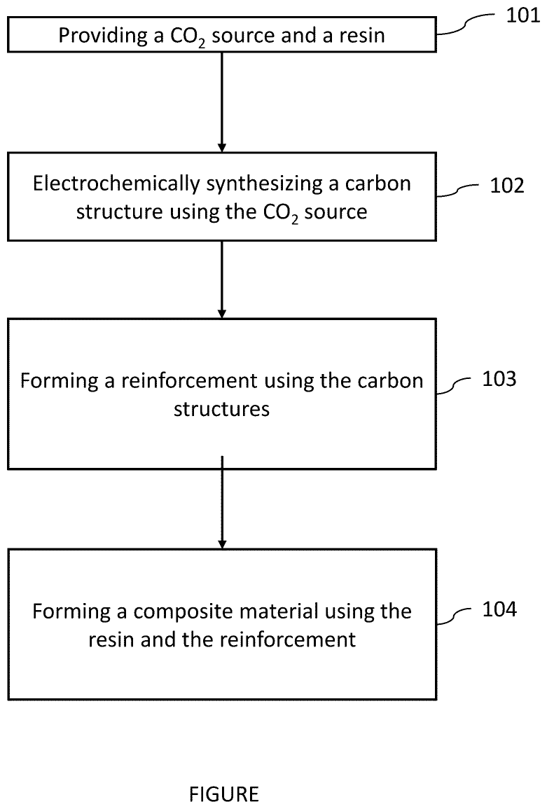

### CROSS-REFERENCE TO RELATED APPLICATIONS

This application claims priority to U.S. Provisional Application No. 63/636,034, filed on Apr. 18, 2024, which is hereby incorporated by reference in its entirety.

### FEDERALLY SPONSORED RESEARCH AND DEVELOPMENT

This invention was made with government support under Cooperative Agreement award No. DE-AR0001643 awarded by Department of Energy's Advanced Research Projects Agency-Energy (ARPA-E). The government has certain rights to this invention.

### FIELD

This disclosure pertains to the field of composite materials, and in particular composite materials that include materials derived from CO₂.

### BACKGROUND

Composite materials have many applications and are found throughout modern life. In particular, composites that are made by combining reinforcing fibers and a polymer matrix can be formed into a wide variety of shapes. By nature, these composite materials are at once lightweight and extremely strong. Of the various composite materials, those including carbon containing fibers find many uses, and are referred to variously as “carbon fiber composites,” CFP, carbon fiber reinforced composites, or even simply “carbon fiber.”

Although carbon fibers provide a very high degree of strength to such composites, conventional carbon fibers are made from non-renewable mineral resources such as oil and natural gas. This is problematic because conventional processing of these mineral resources emits CO₂ into the atmosphere which increases anthropogenic global warming. Parts made from mineral resources are sometimes said to have embodied carbon because their production emits a certain amount of CO₂ into the atmosphere, and that emitted carbon is thereby “embodied” in each part.

It is also problematic because fundamentally, carbon fibers are made of carbon and could conceivably be formed from the CO₂ that is already present in the atmosphere. If carbon fibers could be formed from the CO₂ present in the atmosphere and be formed into a carbon fiber composite, the resulting carbon fiber composite would not only serve its intended purpose (for example, as a useful structural member that is lightweight and strong), but it would also have negative embodied carbon because each manufactured part would remove CO₂ from the atmosphere. The present disclosure is directed to carbon fiber composites and methods for their manufacture having negative embodied carbon.

### SUMMARY

In some aspects, the techniques described herein relate to a polymer composite material including: electrochemically synthesized carbon structures derived from CO₂; and a resin including one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate; wherein the electrochemically synthesized carbon structures include one or more of carbon nanotubes, carbon black, carbon fibers, carbon zoo, carbon flakes, or carbon spherical particles.

In some aspects, the techniques described herein relate to a polymer composite material, further including one or more cellulosic fibers including one or more of bamboo, rice husk, rice straw, sugarcane, pineapple, coconut, cellulose, jute, bagasse, nettle, cotton, hemp, banana, kenaf, agave, sisal, and flax.

In some aspects, the techniques described herein relate to a polymer composite material, further including one or more carbon waste fibers.

In some aspects, the techniques described herein relate to a polymer composite material, wherein one or more carbon waste fibers have an average fiber length greater than about 3 mm.

In some aspects, the techniques described herein relate to a polymer composite material, wherein the polymer composite material includes one of a fiber reinforced composite or a particle reinforced composite.

In some aspects, the techniques described herein relate to a polymer composite material that includes a sandwich structure wherein at least one layer of the sandwich structure includes the electrochemically synthesized carbon structures.

In some aspects, the techniques described herein relate to a polymer composite material, further including one or more of coupling agents, colorants, plasticizers, fillers, pigments, glass fibers, or flame retardants.

In some aspects, the techniques described herein relate to a method of manufacturing a polymer composite material including: providing a CO₂ source and a resin; electrochemically synthesizing a carbon structure from a CO₂ source; forming a reinforcement using the carbon structure; and forming a polymer composite material, wherein forming the polymer composite material comprises mixing the resin and the reinforcement; wherein the carbon structure include one or more of carbon nanotubes, carbon black, carbon fibers, carbon zoo, carbon flakes, carbon spherical particles, and wherein the polymer composite material is formed by one or more of melt processing, injection molding, wet laying and resin filling, compression molding, resin transfer molding, or spray up.

In some aspects, the techniques described herein relate to a method that further includes providing cellulosic fibers wherein forming the reinforcement further uses the cellulosic fibers, and wherein the cellulosic fibers include one or more of bamboo, rice husk, rice straw, pineapple, coconut, cellulose, jute, bagasse, nettle, cotton, hemp, banana, kenaf, agave, sisal, or flax.

In some aspects, the techniques described herein relate to a method that further includes providing carbon waste fibers, wherein forming the reinforcement further uses the carbon waste fibers, and wherein the carbon waste fibers include one or more of recycled carbon fibers or reclaimed carbon waste fibers.

In some aspects, the resin includes one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

In some aspects, the CO₂ source includes one or more of industrial waste exhaust or atmospheric CO₂.

In some aspects, forming the polymer composite material further comprises mixing one or more of coupling agents, colorants, plasticizers, fillers, pigments, glass fibers, or flame retardants into the resin.

### DRAWINGS

The FIG. shows a flow diagram of a method of manufacturing a polymer composite material in accordance with one aspect of the disclosure.

### DETAILED DESCRIPTION

### Composite

Composite materials may be assembled using electrochemically synthesized carbon structures. The electrochemically synthesized carbon structures may be derived from a CO₂ source. In some embodiments, the electrochemically synthesized carbon structures are produced using atmospheric CO₂. In some embodiments, the composite materials comprise one or more of cellulosic fibers or carbon waste fibers. In some embodiments, the composite materials have negative embodied carbon. In some embodiments, the composite material is one or more of a sandwich composite, a fiber reinforced composite, or a particle reinforced composite. In some embodiments, at least one layer of the sandwich composite comprises the electrochemically synthesized carbon structures.

In some embodiments, the composite material comprises a polymer composite material comprising electrochemically synthesized carbon structures. In some embodiments, the electrochemically synthesized carbon structures comprise one or more of carbon nanotubes, carbon black, carbon fibers, carbon zoo, carbon flakes, carbon spherical particles. In some embodiments, the electrochemically synthesized carbon structures are formed using a CO₂ source. The CO₂ source may be any source effective for the formation of carbon structures using electrosynthesis. In some embodiments, the CO₂ source is atmospheric CO₂.

The electrochemically synthesized carbon structures may be present in the composite material in any amount. In some embodiments, the electrochemically synthesized carbon structures are present in the composite material in an amount of about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10 wt. %, about 15 wt. %, about 20 wt. %, about 25 wt. %, about 30 wt. %, about 35 wt. %, about 40 wt. %, about 45 wt. %, about 50 wt. %, or any value or range of values between any two of these values. In some embodiments, the electrochemically synthesized carbon structures are present in the composite material in an amount of about 0.5 wt. % to about 50 wt. %, about 0.5 wt. % to about 20 wt. %, or about 0.5 wt. % to about 10 wt. %.

In some embodiments, the electrochemically synthesized carbon structures comprise carbon fibers. The carbon fibers may have any length effective as a fiber in a composite material. In some embodiments, the carbon fibers comprise a non-woven fiber structure. In some embodiments, the carbon fibers comprise continuous fibers. In some embodiments, the carbon fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10 mm, about 15 mm, about 20 mm, about 25 mm, about 30 mm, about 35 mm, about 40 mm, about 45 mm, about 50 mm, or any value or range of values between any two of these values.

The carbon fibers may have any diameter effective as a fiber in a composite material. In some embodiments, the carbon fibers may have an average diameter of about 5 μm, about 6 μm, about 7 μm, about 8 μm, about 9 μm, about 10 μm, about 11 μm, about 12 μm, about 13 μm, about 14 μm, about 15 μm, or any value or range of values between any two of these values.

In some embodiments, the electrochemically synthesized carbon structures comprise carbon nanotubes. In some embodiments, the carbon nanotubes comprise single-walled carbon nanotubes. In some embodiments, the carbon nanotubes comprise multi-walled carbon nanotubes. The carbon nanotubes may have any diameter effective as a fiber in a composite material. In some embodiments, the carbon nanotubes may have an average diameter of about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or any value or range of values between any two of these values.

In some embodiments, the composite material further comprises a resin. The resin may comprise any resin known to one of skill in the art effective for use in a composite material. In some embodiments, the resin comprises one of a polymer resin or a bio-resin. In some embodiments, the resin comprises one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

The resin may be present in the composite material in any amount. In some embodiments, the resin is present in the composite material in an amount of about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or any value or range of values between any two of these values.

In some embodiments, the composite material comprises one or more cellulosic fibers. Each cellulosic fiber may be made of any material effective for use in a fiber of a composite material. In some embodiments, the one or more cellulosic fibers comprise one or more of bamboo, rice husk, rice straw, sugarcane, pineapple, coconut, cellulose, jute, bagasse, nettle, cotton, hemp, banana, kenaf, agave, sisal, and flax. The cellulosic fibers may be present in the composite material in any amount. In some embodiments, the cellulosic fibers are present in the composite material in an amount of about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, or any value or range of values between any two of these values. In some embodiments the cellulosic fibers are present in the composite material in an amount of about 20 wt. % to about 80 wt. %, about 30 wt. % to about 70 wt. %, or about 40 wt. % to about 60 wt. %. In some embodiments, a weight ratio of the cellulosic fibers as compared to the electrochemically synthesized fibers is about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values.

The cellulosic fibers may have any length effective as a fiber in a composite material. In some embodiments, the cellulosic fibers comprise a non-woven fiber structure. In some embodiments, the cellulosic fibers comprise continuous fibers. In some embodiments, the cellulosic fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10 mm, about 15 mm, about 20 mm, about 25 mm, about 30 mm, about 35 mm, about 40 mm, about 45 mm, about 50 mm, or any value or range of values between any two of these values.

In some embodiments, the composite material comprises carbon waste fibers. In some embodiments, the carbon waste fibers comprise one or more of recycled carbon fibers or reclaimed carbon waste fibers. In some embodiments, the carbon waste fibers comprise waste fibers from carbon fiber production. In some embodiments, the carbon waste fibers comprise chopped carbon fibers. The carbon waste fibers may be present in the composite material in any amount. In some embodiments, the carbon waste fibers are present in the composite material in an amount of about 1 wt. %, about 2 wt. %, about 3 wt. %, about 4 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, or any value or range of values between any two of these values. In some embodiments, the carbon waste fibers are present in the composite material in an amount of about 20 wt. % to about 80 wt. %, about 30 wt. % to about 70 wt. %, or about 40 wt. % to about 60 wt. %. In some embodiments, a weight ratio of the carbon waste fibers as compared to the electrochemically synthesized fibers is about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:50, about 1:100, about 1:200, about 1:300, about 1:400, about 1:500, about 1:600, about 1:700, about 1:800, about 1:900, about 1:1000, or any value or range of values between any two of these values.

The carbon waste fibers may have any length effective as a fiber in a composite material. In some embodiments, the carbon waste fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10 mm, about 15 mm, about 20 mm, about 25 mm, about 30 mm, about 35 mm, about 40 mm, about 45 mm, about 50 mm, or any value or range of values between any two of these values. In some embodiments, the carbon waste fibers have an average length greater than about 1 mm or greater than about 3 mm.

In some embodiments, the composite materials comprise one or more additional additives. The one or more additional additives may comprise any material effective for use in composite materials. In some embodiments, the one or more additional additives comprise one or more of coupling agents, colorants, plasticizers, fillers, pigments, glass fibers, or flame retardants. The one or more additional additives may be present in the composite material in any amount. In some embodiments, the one or more additional additives are present in the composite material in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, or any value or range of values between any two of these values.

### Methods of Manufacturing

Methods may be performed to aid in the manufacturing of the composite materials described above.

The FIGURE depicts an illustrative flow diagram of a method of manufacturing a composite material. The method comprises providing 101 a CO₂ source and a resin. The CO₂ source may be any source effective for the electrochemical synthesis of carbon structures. In some embodiments, the CO₂ source is one or more of industrial waste exhaust or atmospheric CO₂. The industrial waste exhaust may be from any process which produces CO₂ gas emissions. In some embodiments, the industrial waste exhaust comprises exhaust from one of a power plant, chemical processing plant, steel plant, or cement plant. The resin may be any resin effective for use in a composite material. In some embodiments, the resin comprises one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

The method further comprises electrochemically synthesizing 102 carbon structures using the CO₂ source. The carbon structures may comprise any structure effective for use in a composite material. In some embodiments, the carbon structures comprise one or more of carbon nanotubes, carbon black, carbon fibers, carbon zoo, carbon flakes, and carbon spherical particles.

The method further comprises forming 103 a reinforcement using the carbon structures. The reinforcement may be any material effective for producing a composite material known to one of skill in the art. In some embodiments, the reinforcement comprises one of a nonwoven fabric or a woven fabric. In some embodiments, the reinforcement is formed 103 using a wet-laid nonwoven fabric fabrication process.

The method further comprises forming 104 a composite material using the resin and the reinforcement. Forming 104 the composite material using the resin and the reinforcement may comprise mixing the resin and the reinforcement. The composite material may be formed 104 by any process effective for producing composites known to one of skill in the art. In some embodiments, the composite material is formed by one or more of melt processing, injection molding, wet laying and resin filling, compression molding, resin transfer molding, or spray up. The composite material may be formed 104 with any ratio of the reinforcement to the resin effective for use as a composite material. In some embodiments, the weight ratio of the carbon structures to the resin is about 3:1 about 2:1, about 1:1, about 1:2, about 1:3, or any value or range of values between any two of these values. The composite material may be formed 104 with any ratio of the carbon structures to the resin effective for use as a composite material. In some embodiments, the weight ratio of the carbon structures to the resin is about 1:120, about 1:100, about 1:80, about 1:60, about 1:40, about 1:20, about 1:10, about 1:5, about 1:4, about 1:3, about 1:2, about 2:3, or any value or range of values between any two of these values.

In some embodiments, the method further comprises providing cellulosic fibers and forming the reinforcement using the cellulosic fibers. The cellulosic fibers may comprise any fibers effective for use in a composite material. In some embodiments, the cellulosic fibers comprise one or more of bamboo, rice husk, rice straw, sugarcane, pineapple, coconut, cellulose, jute, bagasse, nettle, cotton, hemp, banana, kenaf, agave, sisal, and flax. The composite material may be formed with any ratio of the carbon structure to the cellulosic fibers effective for use as a composite material. In some embodiments, the weight ratio of the carbon structures to the cellulosic fibers is about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values. In some embodiments, the weight ratio of the carbon structures to the cellulosic fibers is between about 1:1 and about 1:2.

In some embodiments, the method further comprises providing carbon waste fibers and forming the reinforcement using the carbon waste fibers. The carbon waste fibers may comprise any fibers effective for use in a composite material. In some embodiments, the carbon waste fibers comprise one or more of recycled carbon fibers or reclaimed carbon waste fibers. The composite material may be formed with any ratio of the carbon structure to the carbon waste fibers effective for use as a composite material. In some embodiments, the weight ratio of the carbon structures to the carbon waste fibers is about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values. In some embodiments, the weight ratio of the carbon structures to the carbon waste fibers is between about 1:1 and about 1:2.

In some embodiments, the method further comprises chopping the carbon waste fibers prior to forming the reinforcement. The carbon waste fibers may be chopped to any length effective for use in a composite material. In some embodiments, the carbon waste fibers are chopped to average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10 mm, about 15 mm, about 20 mm, about 25 mm, about 30 mm, about 35 mm, about 40 mm, about 45 mm, about 50 mm, or any value or range of values between any two of these values. In some embodiments, the carbon waste fibers are chopped to an average length greater than about 1 mm or greater than about 3 mm.

In some embodiments, the method further comprises providing one or more additional additives and forming the composite material using the one or more additional additives. The one or more additional additives may comprise any material known to one of skill in the art effective for use in a composite material. In some embodiments, the additional one or more additives comprise one or more of coupling agents, colorants, plasticizers, fillers, pigments, glass fibers, or flame retardants. The composite material may be formed with any ratio of the carbon structure to the additional additives effective for use as a composite material. In some embodiments, the weight ratio of the carbon structures to the additional additives is about 200:1, about 150:1, about 100:1, about 90:1, about 80:1, about 70:1, about 60:1, about 50:1, about 40:1, about 30:1, about 20:1, about 10:1, about 9:1, about 8:1, about 7:1, about 6:1, about 5:1, about 4:1, about 3:1, about 2:1, about 1:1, about 1:2, about 1:3, about 1:4, about 1:5, or any value or range of values between any two of these values.

This disclosure is not limited to the particular systems, devices and methods described, as these may vary. The terminology used in the description is for the purpose of describing the particular versions or embodiments only and is not intended to limit the scope.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 compounds. Similarly, a group having 1-5 compounds refers to groups having 1, 2, 3, 4, or 5 compounds, and so forth.

1. A polymer composite material comprising:
electrochemically synthesized carbon structures derived from CO₂; and
a resin comprising one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate;
wherein the electrochemically synthesized carbon structures comprise one or more of carbon nanotubes, carbon black, carbon fibers, carbon zoo, carbon flakes, or carbon spherical particles.

2. The polymer composite material of claim 1, further comprising one or more cellulosic fibers comprising one or more of bamboo, rice husk, rice straw, sugarcane, pineapple, coconut, cellulose, jute, bagasse, nettle, cotton, hemp, banana, kenaf, agave, sisal, and flax.

3. The polymer composite material of claim 1, further comprising one or more of recycled carbon fibers or reclaimed carbon waste fibers.

4. The polymer composite material of claim 3, wherein one or more of the recycled carbon fibers or reclaimed carbon waste fibers have an average fiber length greater than about 3 mm.

5. The polymer composite material of claim 1, wherein the polymer composite material comprises one of a fiber reinforced composite or a particle reinforced composite.

6. The polymer composite material of claim 1, wherein the polymer composite material has a sandwich structure wherein at least one layer of the sandwich structure comprises the electrochemically synthesized carbon structures.

7. The polymer composite material of claim 1, further comprising one or more of coupling agents, colorants, plasticizers, fillers, pigments, glass fibers, or flame retardants.

8. A method of manufacturing a polymer composite material comprising:
providing a CO₂ source and a resin;
electrochemically synthesizing a carbon structure from the CO₂ source;
forming a reinforcement using the carbon structure; and
forming a polymer composite material, wherein forming the polymer composite material comprises mixing the resin and the reinforcement;
wherein the carbon structure comprises one or more of carbon nanotubes, carbon black, carbon fibers, carbon zoo, carbon flakes, and carbon spherical particles, and wherein the polymer composite material is formed by one or more of melt processing, injection molding, wet laying and resin filling, compression molding, resin transfer molding, or spray up.

9. The method of claim 8, further comprising:
providing cellulosic fibers;
wherein forming the reinforcement further uses the cellulosic fibers, and
wherein the cellulosic fibers comprise one or more of bamboo, rice husk, rice straw, pineapple, coconut, cellulose, jute, bagasse, nettle, cotton, hemp, banana, kenaf, agave, sisal, or flax.

10. The method of claim 8, further comprising:
providing carbon waste fibers;
wherein forming the reinforcement further uses the carbon waste fibers, and
wherein the carbon waste fibers comprise one or more of recycled carbon fibers or reclaimed carbon waste fibers.

11. The method of claim 8, wherein the resin comprises one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

12. The method of claim 8, wherein the CO₂ source comprises one or more of industrial waste exhaust or atmospheric CO₂.

13. The method of claim 8, wherein forming the polymer composite material further comprises mixing one or more of coupling agents, colorants, plasticizers, fillers, pigments, glass fibers, or flame retardants into the resin.
